(19) United States
(12) Patent Application Publication
(10) Pub. No.: US 2026/0308289 A1
(43) Pub. Date: Oct. 8, 2026

(54) A BIOBASED RADICAL CURABLE COMPOSITION FOR FORMING SOLID OBJECTS

(71) Applicant: ALLNEX BELGIUM, S.A., Drogenbos (BE)

(72) Inventor: Patrice ROOSE, Sint Pieters Leeuw (BE)

(73) Assignee: ALLNEX BELGIUM, S.A., Drogenbos (BE)

(21) Appl. No.: 19/480,910

(22) PCT Filed: May 2, 2024
(86) PCT No.: PCT/EP2024/062056

§ 371 Date: Nov. 3, 2025

(30) Foreign Application Priority Data
May 5, 2023 (EP) 23171913.9

(51) Int. Cl. C08F 122/10; C08F 2/50; C08F 220/18; C08F 290/06; C08F 299/02

(52) U.S. Cl. CPC C08F 122/1006; C08F 2/50; C08F 220/1811; C08F 290/062; C08F 299/024

(57) ABSTRACT

A Biobased Radical Curable Composition for Forming Solid Objects A composition for forming a solid object comprising: ⋅from 10 wt % to 70 wt % of one or more compounds A, each compound A comprising a poly(trimethylene ether) moiety and one or two (meth)acrylate groups; wherein the poly(trimethylene ether) moiety is incorporated into compound A by reaction of a poly(trimethylene ether) glycol having a number average molecular weight Mn of from 500 to 5000 Dalton, and a polydispersity Ð of at least 1.5, ⋅from 30 wt % to 90 wt % of one or more (meth)acrylate compounds B different from compound A, wherein each compound B comprises a single (meth)acrylate moiety and wherein the one or more (meth)acrylate compounds B, if polymerized together, have a Tg of more than 30° C.; and ⋅from 0 wt % to 25 wt % of other compounds C, different from compounds A and B, wherein the viscosity of the composition is less than 5 Pa·s.

### FIELD OF THE INVENTION

The present invention relates to a free-radical curable composition, and more in particular to biobased compositions for forming a solid object, for instance, by additive manufacturing.

### BACKGROUND OF THE INVENTION

Radical-curing is an established technology that processes a liquid reactive resin into a polymerized coating, ink, laminating adhesive, or water-proofing membrane, typically as a single layer attached to a substrate. This polymerization forms a crosslinked polymer network, known as a thermoset.

The traditional method to manufacture solid objects from radical curing is mold-casting, usually with thermal radical initiation to activate the polymerization. Resin infusion, used in combination with reinforcing elements such as fibers, has also been used to produce composite materials.

The advent of additive manufacturing techniques has expanded the application field to create self-supporting parts and objects with very complex geometries and structures, even down to the microscale. These light-based 3D printing techniques include stereolithography (SLA), digital light processing (DLP), material jetting, and two-photon polymerization (2PP). A review of the additive photopolymerization methods is provided in F. Zhang et al., “The recent development of vat photopolymerization: A review”, Additive Manufacturing 48, 102423 (2021).

The mechanical stiffness of a solid part is an important factor when considering its strength and durability. To reduce the risk of failure, it is also necessary to consider the brittleness and impact properties of the material. Toughness energy, or the amount of energy needed for the material to break down upon deformation or shock, can help to determine the best material for the part. (Meth)acrylated derivatives are a popular choice for this purpose due to their efficient curing process, wide range of chemical forms (epoxy, polyester, polyether, or polyurethanes), and availability from petrochemical feedstocks. (Meth)acrylate compositions typically involve viscous precursors (oligomers) to control the properties of the object after curing. To increase flexibility or toughness, a soft/flexible precursor is added to the formulation. Urethane acrylates with long polyether or polyester segments are typically used as soft oligomers.

Thinning the resin viscosity is often a prerequisite in nearly any application, and is achieved with the aid of reactive diluents in solventless formulations. As small functional molecules, reactive diluents build stiffness and strength upon curing, but if added in excess can lead to unacceptable brittleness. Formulation steps are needed to find a suitable trade-off between fluid viscosity for processing and the properties of the applied material after curing, such as stiffness, toughness, solvent/stain resistance, and glass transition properties. This challenge is amplified for resins with low viscosities, which are often required for 3D printing applications. US20220411560 describes such a photopolymerizable composition comprising a blend of urethane component, monofunctional reactive diluent, initiator and amine-functional (meth)acrylate monomer for use in additive manufacturing.

However, thermoset parts manufactured from fossil-based compounds are difficult to recycle and often not biodegradable. Upon reaching their service life, they are typically incinerated and contribute to rising carbon dioxide levels in the atmosphere. There is therefore a need in the art for improved polymeric materials suitable for 3D printing and that overcome, at least partially, one or more of the above issues.

### SUMMARY

It is hence an object of the present invention to develop a free-radical curable composition for forming a solid object that can be biobased.

The free-radical curable compositions of the present invention may have one or more of the following advantages:

They may have a high reactivity.

They may have a low viscosity. The unique viscosity levels of embodiments of the present invention make them suitable for additive manufacturing, i.e., 3D printing, and thermoset composite manufacturing, e.g. by resin infusion. By substituting a low molecular mass non-biobased, viscous precursor with a higher molar mass and typically biobased component (component A), these embodiments enable toughness and flexibility enhancements while still maintaining a low viscosity.

They may have tunable mechanical properties for various applications after curing. In particular, the composition can be tailored in order to achieve a right balance between toughness/flexibility and stiffness at a high biobased content keeping the viscosity level low. Thereby strong and durable objects that have a low risk of failure can be achieved.

They may comprise less volatile organic compounds and, hence, may have low toxicity and low flammability.

They may be solvent and/or stain resistant.

They may remain solid over a large range of temperatures.

They may have a high biobased content and, thereby, be relatively environmentally friendly.

To this end, in the first aspect, the present invention relates to a radical curable composition for forming a solid object comprising the following compounds:
from 10 wt % to 70 wt % based on the total weight of the composition, of one or more compounds A, each compound A comprising a poly(trimethylene ether) moiety and one or two (meth)acrylate groups; wherein the poly(trimethylene ether) moiety is incorporated into compound A by reaction of a poly(trimethylene ether) glycol having a number average molecular weight Mn, measured by GPC with polystyrene as the standard, of from 500 to 5000 Dalton, and a polydispersity D, measured by GPC with polystyrene as the standard, of at least 1.5,
from 30 wt % to 90 wt % based on the total weight of the composition, of one or more (meth)acrylate compounds B different from compound A, wherein each compound B comprises a single (meth)acrylate moiety and wherein the one or more (meth)acrylate compounds B, if polymerized together, have a Tg of more than 30° C.; and
from 0 wt % to 25 wt % of other compounds C, different from compounds A and B, wherein the viscosity of the whole composition is less than 5 Pa·s, more preferably less 4.8 Pa·s; more preferably less than 4.5 Pa·s, even more preferably less than 2 Pa·s, yet more preferably less than 1 Pa·s, less than 0.5 Pa·s or less than 0.1 Pa·s, or even less than 0.085 Pa·s at 25° C.

In a second aspect, the present invention relates to the use of a radical curable composition according to any embodiments of the first aspect for forming a solid self-supporting object.

In a third aspect, the present invention relates to a method of forming a solid object comprising submitting the radical curable composition according to any embodiment of the first aspect, to curing conditions.

In a fourth aspect, the present invention relates to a solid object comprising a cured radical curable composition according to any embodiment of the first aspect.

### DETAILED DESCRIPTION OF THE INVENTION

In the first aspect, the present invention relates to a radical curable composition for forming a solid object comprising the following compounds:
from 10 wt % to 70 wt % based on the total weight of the composition, of one or more compounds A, each compound A comprising a poly(trimethylene ether) moiety and one or two (meth)acrylate groups; wherein the poly(trimethylene ether) moiety is incorporated into compound A by reaction of a poly(trimethylene ether) glycol having a number average molecular weight Mn, measured by GPC with polystyrene as the standard, of from 500 to 5000 Dalton, and a polydispersity D, measured by GPC with polystyrene as the standard, of at least 1.5,
from 30 wt % to 90 wt % based on the total weight of the composition, of one or more (meth)acrylate compounds B different from compound A, wherein each compound B comprises a single (meth)acrylate moiety and wherein the one or more (meth)acrylate compounds B, if polymerized together, have a Tg of more than 30° C.; and
from 0 wt % to 25 wt % of other compounds C, different from compounds A and B, wherein the viscosity of the whole composition is less than 5 Pa·s, more preferably less 4.8 Pa·s, more preferably less than 4.5 Pa·s, even more preferably less than 2 Pa·s, yet more preferably less than 1 Pa·s, less than 0.5 Pa·s or less than 0.1 Pa·s, or even less than 0.085 Pa·s at 25° C.

The composition of the first aspect is, at least partially, curable by the action of free-radicals by virtue of compounds A and B being polymerizable by the action of free-radicals. For instance, it can be cured by an electron beam, by the combination of a photoinitiator, which may be comprised in compound C, and actinic radiations. The actinic radiation may, for example, comprise near-infrared radiation, ultra-violet radiations at a wavelength of from 200 to 400 nm or visible light at a wavelength of from 400 to 450 nm (e.g., generated by an LED), or by thermally generated radicals (e.g., originating from the thermal decomposition of a thermal radical initiator such as a peroxide or an azo compound). With UV light radiation is meant irradiation via a ultraviolet light source including high or low-pressure mercury lamps, cold cathode tubes, xenon lamps, black lights, ultraviolet lasers, flash lights, and LED light sources. Typically the wavelength of a UV light source is between 240 and 379 nm. Typically, the wavelength of suitable visible light source is between 380 and 500 nm, preferably from 380 to 405 nm. With radiation using LED light sources is meant irradiation via a light-emitting diode source, whereby a semiconductor light source is used. Typically a wavelength of 365, 385, 395 or 405 nm is used.

In embodiments, the composition may be for forming a self-supporting solid object. By self-supporting, it is meant that the solid object may have an overall shape and/or size that can be maintained without the need for any external support.

In embodiments, minimal dimensions of the solid object may have any size, e.g., its width may be 20 μm or higher, 50 μm or higher, 100 μm or higher, 200 μm or higher, 500 μm or higher, 1 mm or higher, or 1 cm or higher. Its length and its height may be equal or higher than its width.

In embodiments, the object may comprise features having a width of 10 μm or higher.

The solid object can have any shape and any aspect ratio. Examples of aspect ratio between its largest dimension and its smallest dimension are from 1:1 to 20:1.

In embodiments, the composition may comprise from 12 to 65 wt %, preferably 12 to 60 wt % of compound A, more preferably 15 wt % to 50 wt %, yet more preferably from 20 wt % to 40 wt %, even more preferably from 25 wt % to 35 wt %.

It was also surprisingly found that compound A having at most 2 (meth)acrylate groups can be used as a diluting monomer, providing the same or even better performances compared to di-(meth)acrylate monomers that are known in the market such as tripropylene glycol diacrylate or dipropylene glycol diacrylate. Further, it is found that this compound is a good replacement compared to other well-known biobased monomers such as propoxylated glycerol triacrylate (also called OTA). In addition, compound A is able the soften the harder oligomers so that the solid object, e.g., 3D part, formed after curing of the composition, is less brittle when compared with other types of known monomers, when used at the same concentration.

In embodiments, the poly(trimethylene ether) glycol reacted to incorporate the poly(trimethylene ether) moiety in compound A has a polydispersity D, measured by GPC with polystyrene of at most 3.4, preferably at least 1.6 and at most 2.5.

In embodiments, at least some of the poly(trimethylene ether) (meth)acrylate compounds A may be obtainable by a condensation reaction of 1,3 poly(trimethylene ether) glycol (which can be biobased) and a (meth)acrylate compound which is selected from the group consisting of (meth)acrylic acid, (meth)acryloyl chloride, and/or alkyl esters thereof. The alkyl ester thereof preferably has a formula of H₂C═C(R)CO₂—R¹—COOH, or H₂C═C(R)CO₂—R¹—Cl, wherein R is H or CH₃, R¹ is a divalent linear alkyl radical having in the range of form 1 to 20, preferably 1 to 5, carbon atoms, a divalent branched alkyl radical having in the range of from 3 to 20 carbon atoms, or a divalent radical having cycloalkyl radical having in the range of from 5 to 10 carbon atoms. This is advantageous because it gives rise to compositions having a relatively low viscosity and to the formation of objects having a very good impact resistance when compared to compositions involving the formation of a urethane acrylate. For each compound A obtained by such a condensation, the condensation reaction, or esterification, is preferably carried out by reacting 1,3 poly(trimethylene ether) glycol with a stoichiometric excess of (meth)acrylate groups present on the (meth)acrylate compound selected from the group consisting of (meth)acrylic acid, (meth)acryloyl chloride, and/or alkyl esters thereof. The reactants are generally used in proportions corresponding to an equivalent ratio of (meth)acrylate groups to alcohol groups of the 1, 3 poly(trimethylene ether) glycol of between 2.0:1.0 and 2.2:1.0. For preparation of each of the poly(trimethylene ether) (meth)acrylate compound A having at most two (meth)acrylate groups obtainable by such a condensation, 1, 3 poly(trimethylene ether) glycol can be contacted, preferably in the presence of a gas, with the (meth)acrylate compound at a temperature from about 25° C. to about 250° C. The process can be carried out at atmospheric pressure or under vacuum. During reaction, water is formed and can be removed in the inert gas stream or under vacuum to drive the reaction to completion. For each compound A obtained by such a condensation, to facilitate the reaction of poly(trimethylene ether) glycol with the (meth)acrylate compound, an esterification catalyst is generally used, preferably a mineral acid catalyst. Examples of acid catalysts include but are not restricted to sulfuric acid, aryl or alkyl sulfonic acid, triflic acid, hydriodic acid, and heterogeneous catalysts such as zeolites, heteropolyacid, amberlyst, dialkyl tin dilaurate, titanium alkoxide and ion exchange resin. Preferred esterification acid catalysts are selected from the group consisting of sulfuric acid, p-toluenesulfonic acid, methanesulfonic acid, triflic acid, dialkyl tin dilaurate, titanium alkoxide, and hydroiodic acid. The particularly preferred acid catalyst are sulfuric acid, triflic acid and ion exchange resins. The amount of catalyst used can be from about 0.01 wt % to about 10 wt % of the reaction mixture, preferably from 0.1 wt % to about 5 wt %, and more preferably from about 0.2 wt % to about 2 wt %, of the reaction mixture. To prevent free radical polymerization of (meth)acrylic esters of poly(trimethylene ether) glycol, an inhibitor is used, preferably 4-methoxyphenol. Examples of inhibitors include but are not restricted to alkyl phenols, alkoxyphenol, hydroxybenzyl alcohol and hydroquinone. The amount of the inhibitor can be from about 0.001 to 5 wt % of the product. A preferred range is from about 0.01 to 2.0 wt %. The esterification reaction can be conducted in the presence or absence of a solvent. Examples of solvents include but are not restricted to acetonitrile, cyclohexane, hexane, methylcyclohexane, heptane, octane, tetrahydrofuran, toluene and xylene. A preferred solvent is acetonitrile or toluene. The amount of solvent used can be from about 0 wt % to about 100 wt % of the reaction mixture, preferably from 20 wt % to about 100 wt %, and more preferably from about 50 wt % to about 100 wt %, of the reaction mixture.

In embodiments, at least some of the poly(trimethylene ether) (meth)acrylate compound A may be obtainable by reacting 1,3 poly(trimethylene ether) glycol (which can be biobased) with a diisocyanate and an a (meth)acrylate compound comprising an (meth)acrylate moiety and a moiety that can react with a isocyanate group (e.g., a hydroxyl group), thereby forming an urethane (meth)acrylate. These composition are advantageous because they may result in solid objects that are harder, more resistant to deformation, and more heat resistant. Examples of such (meth)acrylate compounds are hydroxyethyl (meth)acrylate, hydroxypropyl (meth)acrylate, ethylene glycol mono(meth)acrylate, propylene glycol mono(meth)acrylate, diethylene glycol mono(meth)acrylate, and triethylene glycol mono(meth)acrylate. Examples of diisocyanate compounds are aliphatic and aromatic diisocyanates such as 1,4-toluene diisocyanate, 1,5-naphthalene diisocyanate, 2,4-toluene diisocyanate, 4,4′-diphenylmethane diisocyanate, hexamethylene diisocyanate, isophorone diisocyanate, cyclohexane-1,3- and -1,4-diisocyanate, and trimethylhexane-1,6-diisocyanate.

For each compound A obtained by a reaction involving a diisocyanate, the reaction is preferably carried out by reacting 1,3 poly(trimethylene ether) glycol with at least 1.1 equivalent of diisocyanate, e.g., from 1.2 to 2.5 equivalents of diisocyanate and from 0.9 to 2.5 equivalent of the (meth)acrylate compound.

For each compound A, the 1,3 poly(trimethylene ether) glycol may be obtained biochemically from a renewable source. This can be via a fermentation process using a renewable biological source such as e.g. corn feed stock. Examples of commercially available biobased 1,3 poly(trimethylene ether) glycol can be obtained from, for example, WeylChem® and are e.g. described in patent application WO2010/074805.

Preferably each of the poly(trimethylene ether) (meth)acrylate compound A obtainable by the condensation reaction, comprises at least 90 wt %, more preferably at least 95 wt %, or at least 99 wt % of poly(trimethylene ether) di-(meth)acrylate in view of the total poly(trimethylene ether) (meth)acrylate compound A.

In embodiments, the composition may comprise from 35 wt % to 88 wt %, preferably 40 wt % to 88 wt % of compound B, preferably, from 50 to 85 wt %, more preferably from 60 to 80 wt %, yet more preferably from 65 to 75 wt %, based on the total weight of the composition.

In embodiments, each compound B has a number average molecular weight Mn of at most 500 Dalton, preferably at most 250 Dalton.

In embodiments, at least one of the compounds B may be selected from isobornyl acrylate, isobornyl methacrylate, norbornyl acrylate, norbornyl methacrylate, α-methylene-γ-butyrolactone, α-methylene-γ-valerolactone, methyl methacrylate (MMA), n-butyl methacrylate (BuMA), tert-butyl methacrylate (tBuMA), cyclohexyl methacrylate (CHMA), tert-butyl cyclohexyl acrylate, benzyl methacrylate (BMA), hydroxyethylmethacrylate (HEMA), hydroxypropyl methacrylate (HPMA), (meth)acrylic acid, beta-carboxyethyl acrylate, isobutyl (meth)acrylate, 2-ethylhexyl(meth)acrylate, n-hexyl (meth)acrylate, isooctyl (meth)acrylate, n-lauryl (meth)acrylate, octyl/decyl (meth)acrylate, phenoxyethyl(meth)acrylate, nonylphenolethoxylate mono(meth)acrylate, 2-(-2-ethoxyethoxy)ethyl(meth)acrylate, 2-butoxyethyl (meth)acrylate, and N-vinyl pyrrolidone, 4-acryloylmorpholine (ACMO), phenylglycidylether(meth)acrylate, and the ethoxylated or/and propoxylated derivatives thereof, the (meth)acrylates obtained from the esterification with (meth)acrylic acid of aliphatic glycidyl ethers, especially those wherein the alkyl chain comprises from 6 to 24 carbon atoms, more preferably from 8 to 18 carbon atoms, and/or of glycidyl esters of saturated and unsaturated carboxylic acids, especially the glycidyl esters of long chain alkyl carboxylic acids wherein the alkyl chain comprises from 6 to 24 carbon atoms, more preferably from 8 to 18 carbon atoms.

In embodiments, the one or more (meth)acrylate compounds B, if polymerized together, may have a Tg of more than 30° C.

In embodiments, the composition may comprise from 0 wt % to 15 wt %, preferably from 0 wt % to 9 wt % of other compounds C, different from compounds A and B.

In embodiments, the biocarbon content of the ensemble of the one or more compounds A is more than 5%, preferably above 30%, more preferably above 50%, even more preferably above 60%, by weight of the total carbon content, wherein the biocarbon content is measured using the accelerated mass spectrometry protocol described in the standard ASTM D 6866-22.

In embodiments, the biocarbon content of the ensemble of the one or more (meth)acrylate compounds B totalizes more than 5%, preferably above 30%, more preferably above 50%, even more preferably above 60%, by weight of the total carbon content, wherein the biocarbon content is measured using the accelerated mass spectrometry protocol described in the standard ASTM D 6866-22.

In embodiments, the biocarbon content of the composition is more than 5%, preferably above 30%, more preferably above 50%, even more preferably above 60%, by weight of the total carbon content, wherein the biocarbon content is measured using the accelerated mass spectrometry protocol described in the standard ASTM D 6866-22.

Currently, there exists at least two different techniques for measuring the ¹⁴C content of a sample (i) by liquid scintillation counting or (ii) by mass spectrometry in which the sample is transformed in CO₂ and then reduced to graphite for analysis in the mass spectrometer to separate the ¹⁴C atoms from the ¹²C atoms and determine their ratio. All these methods for measuring the ¹⁴C content of substances are clearly described in the American standards ASTM D 6866 or ASTM D 7026 as well as in the European standards EN 16785 or EN 16640.

The values of the biobased carbon content according to his invention are measured using the accelerated mass spectrometry protocol described in the standard ASTM D 6866-22.

In embodiments, the viscosity of the whole composition may be less than 5 Pa·s, preferably less than 2 Pa·s, more preferably less than 0.5 Pa·s, even more preferably less than 0.1 Pa·s, and most preferably less than 0.085 Pa·s at 25° C.

Viscosities are as measured with a rotational viscosimeter (cone and plate) according to DIN EN ISO 3219 with shear rate 20 s⁻¹ at 25° C.

The composition of the first aspect is preferably liquid at 25° C.

In embodiments, component C may comprise one or more radical initiators. Each radical initiator can be selected from thermal initiators and photoinitiators. Preferably one or more photoinitiators are used.

Typically, when present, the radical initiators are preferably present from 0.1 wt % to 10 wt % of the total weight of the composition.

Examples of suitable UV photoinitiators are benzophenone, benzoin ethyl ether, benzoin methyl ether, anthraquinone, 2-methyl-1-[4-(methylthio)phenyl]-2-morpholinopropan-1-one, 2-hydroxy-2-methyl-1-phenylpropane-1-one, and combinations thereof.

Examples of suitable visible light photoinitiators are bis(eta.5-2,4-cylcopentadien-1-yl)-bis(2,6-difluoro-3-(1H-pyrrol-1-yl)-phenyl) titanium (Irgacure 784), 2,4,6-trimethylbenzoyl diphenylphosphine oxide (TPO), 2,4,6-trimethylbenzoyl phenyl, ethoxy phosphine oxide (TPO-L), and bis(2,4,6-trimethylbenzoyl)-phenylphosphineoxide (Irgacure 819) In embodiments, compound C can comprise one or more (meth)acrylate compounds D different from the one or more compounds A or B, and wherein each compound D comprises two or more (meth)acrylate groups.

When present, compounds D may be present in an amount up to 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition.

In embodiments, compound C can comprise compounds E1 having a poly(trimethylene ether) moiety and only one (meth)acrylate group, wherein the poly(trimethylene ether) moiety is incorporated into compound E1 by a reaction of a poly(trimethylene ether) glycol, the poly(trimethylene ether) glycol having a number average molecular weight Mn, measured by GPC with polystyrene as the standard, below 500 Dalton.

When present, compounds E1 may be present in an amount up to 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition. Preferably, no compounds E1 is present.

In embodiments, compound C may comprise compounds E2 having a poly(trimethylene ether) moiety and only one (meth)acrylate groups; wherein the poly(trimethylene ether) moiety is incorporated into compound E2 by a reaction of a poly(trimethylene ether) glycol, the poly(trimethylene ether) glycol having a number average molecular weight Mn, measured by GPC with polystyrene as the standard above 5000 Dalton, e.g. above 5500 Dalton. When present, compounds E2 may be present in an amount up to 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition.

In embodiments, compound C may comprise a polymer compound F having no ethylenically unsaturated groups. Examples of such polymers are saturated polyesters, halogenated or not, hydrocarbons (such as styrene based hydrocarbon resins), styrene allyl alcohols, acrylics (such as acrylic (co)polymers), (poly)urethane resins, polyethylenevinylacetate resins, polyvinyl acetate, polyvinyl butyral, polyvinyl alcohol, polyvinylchloride resins, chlorinated polyolefin resins and/or ketone resins. Other types of polymers can be biobased polymers such as polymers and copolymers of lactic acid, cellulose esters (such as cellulose acetate, cellulose propionate, cellulose butyrate and combinations thereof), polyhydroxyalkanoates (e.g. polyhydroxybutyrate and copolymers), lignin derivatives, hemicellulose derivatives, etc. When present, compounds F are preferably present in an amount up to 25 wt %, preferably at most 15 wt %, more preferably at most 10 wt %, more preferably at most 5 wt %, yet more preferably at most 2 wt %, even more preferably at most 1 wt %, and most preferably at most 0.2 wt % of the composition.

In embodiments, compound C may comprise one or more inhibitors G. Examples of suitable inhibitors include but are not limited to phenolic inhibitors such as hydroquinone (HQ), methyl hydroquinone (THQ), tert-butyl hydroquinone (TBHQ), parabenzoquinone (BQ), 4-tert butyl catechol, di-tert-butyl hydroquinone (DTBHQ), hydroquinone monomethyl ether (MEHQ), 2,6-di-tert-butyl-4-methylphenol (BHT) and the like. They may also include phosphines, like triphenylphosphine (TPP) and other materials such as tris-nonylphenylphosphite (TNPP), phenothiazine (PTZ), and triphenyl antimony (TPS). When present, inhibitors are preferably present in an amount up to 0.5 wt %, in particular from 0.0001 to 0.2 wt %, and preferably from 0.01 to 0.1 wt % of the composition.

Photostabilizers can be classified as UV absorbers (UVAs), deactivators (quenchers), hydroperoxide decomposers, and radical scavengers known as hindered amine light stabilizers (HALS).

In embodiments, compound C may comprise one or more UV absorber (UVA) and/or a hindered amine light stabilizer (HALS) H. The UVAs protect the polymers by absorbing destructive UV radiation, while the HALS material protects by reacting with the free radicals that occur after a high-energy UV photon breaks a chemical bond in a polymer.

Examples of UVAs are benzotriazoles such as Tinuvin® 328, Tinuvin® 1130, Tinuvin® 900, Tinuvin® 99-2, and Tinuvin® 384-2, triazines such as Tinuvin® 400, Tinuvin® 405, Tinuvin® 460, Tinuvin® 477, and Tinuvin® 479, and benzophenones such as Tinuvin® 531.

Examples of HALS are Tinuvin® 123, Tinuvin® 144, and Tinuvin® 292, 2,2,6,6-tetramethylpiperidine and 2,6-di-tert-butylpiperidine.

Photostabilizers, when present in compound C, may be used in an amount of from 0.1 to 5.0 wt %, preferably from 0.5 to 2.5 wt % of the composition.

Compound C may comprise further additives such as fiber wetting agents e.g. functionalized silanes; and (acidic) adhesion promotors.

In embodiments, compound C can comprise a solvent, e.g. a biobased solvent, to decrease the viscosity. A solvent is not preferred. The biobased carbon content may be higher when no solvent is added to the composition. When present, the solvent may be present in an amount up to 10 wt % of the composition.

Compound C may comprise other conventional ingredients including pigments, dyes, heat stabilizers, defoamers, leveling agents, fillers, sedimentation inhibitors, antioxidants and the like introduced at any stage of the preparation process or subsequently.

In embodiments, the composition may be for forming a solid object having a Young's modulus measured at 23° C. of more than 95 MPa, preferably more than 150 MPa, yet more preferably more than 200 MPa.

In embodiments, the composition may be for forming a solid object having an impact energy of at least 1.0 kJ m⁻², preferably at least 2.0 kJ m⁻².

In preferred embodiments, the composition may be for forming a solid object which has simultaneously a Young's modulus measured at 23° C. of more than 95 MPa and an impart energy of 0.8 kJ m⁻² and even more at least 1.0 kJ m⁻².

Any feature of the first aspect can be as correspondingly described in any of the other aspects.

In the second aspect, the present invention relates to the use of a radical curable composition according to any embodiments of the first aspect for forming a solid self-supporting object.

In embodiments, the use may be in additive manufacturing, molding, or casting.

Any feature of the second aspect can be as correspondingly described in any of the other aspects.

In the third aspect, the present invention relates to a method of forming a solid object comprising submitting the radical curable composition according to any embodiment of the first aspect, to curing conditions.

The application temperature is the temperature the radical curable composition has when the composition is cured. In most cases the application temperature is room temperature, e.g., 25° C., but sometimes it can be higher.

When compound C comprises a thermal radical initiator, i.e., a radical initiator that is activated thermally, the curing conditions may comprise applying a temperature adapted for forming radicals from the thermal radical initiator. Preferably, the temperature is not raised above 300° C. This is advantageous as it avoids thermal decomposition of the composition. It also avoids unnecessarily high thermal budgets.

In embodiments, the curing conditions may be selected from peroxide curing, LED curing, UV curing and/or electron beam curing.

In embodiments, the method comprises performing a technique for forming objects selected from additive manufacturing, molding, or casting of the radical curable composition. The curing conditions may be applied while performing said technique.

Any feature of the third aspect can be as correspondingly described in any of the other aspects.

In the fourth aspect, the present invention relates to a solid object comprising a cured radical curable composition according to any embodiment of the first aspect.

In embodiments, the solid object may be a self-supporting object.

In embodiments, the solid object may be formed by additive manufacturing, molding, or casting.

Preferably, the T_{g} of the solid object may be at least 30° C., preferably at least 40° C., yet more preferably at least 50° C., and most preferably at least 70° C. Typically, it is lower than 160° C., such as lower than 140° C.

The T_{g} is determined using dynamical mechanical thermal analysis (DMTA) on 3D printed test samples of the cured radical curable composition, as described by the standard method ASTM D4065-01 (Standard test method for the assignment of the glass transition temperature by Dynamic Mechanical Analysis). Herein, the T_{g} is determined as the temperature at the maximum of the loss factor curve (i.e., T(tan δₘₐₓ)).

Any feature of the fourth aspect can be as correspondingly described in any of the other aspects.

### EXAMPLES

Techniques used to form 3D parts from the compositions and determine their properties.

### Viscosity

Viscosities η are measured according to DIN EN ISO 3219 using a rotational rheometer at a shear rate of 20 s⁻¹.

### Sample Preparation Using 3D Printing

From the compositions, test parts (rectangular and dogbone shapes) were formed by additive manufacturing using vat photopolymerization. To this end, a DLP (Digital Light Processing) printer of Wanhao (model Duplicator 7) was used. The composition contained 2 w/w % of the photoinitiator TPO-L (ethyl(2,4,6-trimethylbenzoyl)-phenyl phosphinate). The printer operated using UV-LED light at a wavelength of 405 nm and an intensity of 5 mW/cm². The 3D part was built in layers of 100 μm thickness, each exposed for 30 s to UV light. When printed, the part was removed and rinsed with isopropanol and finally submitted to a post-curing step (exposure to UVLED light at 365 nm with an intensity of 100 mW cm⁻² for 1 minute each side) to further strengthen the formed objects. This resulted in complete conversion of the of the (met)acrylate groups.

### Glass Transition Temperature by Dynamic Mechanical Thermal Analysis

The glass transition temperature (T_{g}) marks the boundary between the glassy, rigid state and the softer relaxed state of a polymer or polymer network which can be rubbery or even fluid.

In these examples, dynamical mechanical thermal analysis (DMTA) was conducted with 3D printed samples (thickness 1 mm) as described by the standard method ASTM D4065-01 (Standard test method for the assignment of the glass transition temperature by Dynamic Mechanical Analysis). The 3D printed samples were prepared according to the procedure described above as “Sample preparation using 3D printing”. DMTA measurements were conducted using a DMA Q800 (TA Instruments) instrument in tensile mode. The dimensions of the samples between the clamps were typically 11 mm×8.0 mm×1 mm. A periodic strain deformation was applied with an amplitude of 30 μm at a frequency of 1 Hz. The viscoelastic properties are measured following a temperature profile increasing from −50 to 200° C. at a heating rate of 3° C. per minute. The T_{g} is determined as the temperature at the maximum of the loss factor curve (i.e., T(tan δₘₐₓ)).

### Tensile Properties

Young's modulus or tensile modulus of elasticity is a mechanical property that provides an index for the degree of stiffness of a solid material. It defines the relationship between tensile stress (force per unit area, pressure units) and tensile strain (relative deformation, dimensionless) of a material for small uniaxial deformation. Young's modulus (E_{Y}) is the ratio of the tensile stress to the tensile strain, and is reported in pressure units. The ultimate tensile elongation (UTE) or elongation at break describes how much the material can be deformed before failure and is defined as the percentage change in length from an non-elongated state of the material (i.e., no force applied) to the elongated state of the material where failure of the material occurs. Tensile properties are reported for 3D printed test parts in the shape of a dogbone (dumbbell) with a central length of 30 mm and a thickness of 1 mm. The 3D printed samples were prepared according to the procedure described above as “Sample preparation using 3D printing”. The properties were measured at a temperature of 23° C. according to one of the following standard methods for the determination of tensile properties, ASTM D638 (Standard Test Method for Tensile Properties of Plastics), ASTM D882 (Standard Test Method for Tensile Properties of Thin Plastic Sheeting) or ISO527-1 (Plastics—Determination of tensile properties).

### Izod Impact Test

Izod impact test was performed as per the standard ISO180 using a pendulum impact tester IT503 (Tinius Olsen). Machine and specimen setup was made as per ISO test procedure. The standard specimen for ISO is a Type 1A multipurpose specimen. The resulting test sample measures 80×10×4 mm (or 8 mm). The depth under the notch of the specimen is 8 mm. The samples were prepared according to “sample preparation using 3D printing”.

ISO impact strength is expressed in kJ m⁻². The impact strength is calculated by dividing impact strength in J by the area under the notch. The test result is typically the average of at least 4 specimens.

### Biobased Content

In the examples, the biobased content (BBC) of the compositions was estimated theoretically according to the guidelines provided in EN 16785-1.

### Examples of (Meth)Acrylates for Use in Radical Curable Compositions

Commercial poly(trimethylene ether) glycol Velvetol® H250, H500, H1000, H2000, and H2700 were used as starting materials.

Table 0 summarizes their characteristics.

| Velvetol ® | Mₙ (Da) | M_{w} (Da) | Ð | η (mPa s) |
|---|---|---|---|---|
| H250 | 462 | 600 | 1.30 | 112 |
| H500 | 965 | 1525 | 1.58 | 240 |
| H1000 | 1666 | 3065 | 1.84 | 510 |
| H2000 | 2877 | 6330 | 2.20 | 1725 |
| H2700 | 3710 | 8830 | 2.38 | 3215 |

Table 1 summarizes a range of diacrylated compounds, used in the examples of compositions in accordance with embodiments of the present invention. Herein, PPDA500, PPDA1000, PPDA2000 and PPDA2700 may be used as compound A as described in embodiments of the first aspect of the present invention. PPDA250 may be used as compound C as described in embodiments of the first aspect of the present invention. The compounds comprise a poly-trimethylene ether moiety and two (meth)acrylate groups, that are formed by a condensation reaction of a poly(trimethylene ether) glycol, of which the commercial name is indicated as the poly(trimethylene ether) glycol precursor, with (meth)acrylic acid. The reaction was performed using techniques known in the art such as those described in WO2010074805. The reported number average molecular weight Mₙ, and the reported weight average molecular weight M_{w}, were measured by GPC with polystyrene as the standard and tetrahydrofuran (THF) as the elution solvent. The polydispersity Ð=M_{w}/Mₙ was derived therefrom. Viscosities, measured using the technique described above, are also summarized in Table 1.

TABLE 1
Molar mass distribution and viscosity data of several di(meth)acrylated
poly(trimethylene ether) glycol compounds

| | Poly(trimethylene | Mₙ | M_{w} | | η_{25° C.} | BBC |
|---|---|---|---|---|---|---|
| Compound | ether) glycol | (Da) | (Da) | Ð | (mPa s) | (%) |
| PPDA250 | Velvetol ® H250 | 480 | 630 | 1.31 | 21 | 63 |
| PPDA500 | Velvetol ® H500 | 970 | 2930 | 3.02 | 160 | ND |
| PPDA1000 | Velvetol ® H1000 | 1560 | 3005 | 1.93 | 385 | ND |
| PPDA2000 | Velvetol ® H2000 | 2830 | 6590 | 2.33 | 2000 | ND |
| PPDA2700 | Velvetol ® H2700 | 3530 | 9395 | 2.66 | 2940 | 94 |

Table 2 summarizes the glass transition temperatures and tensile properties for 3D printed parts prepared according to the procedure described above as “Sample preparation using 3D printing”. In this context, we define the glass transition temperature T_{g} as the temperature at which the loss factor curve reaches its maximum value (i.e. T(tan δₘₐₓ)). Young's modulus (E_{Y}) and the ultimate tensile elongation (UTE) were determined using the methods described above. These measurements were performed on various di(meth)acrylated poly(trimethylene ether) glycol compounds, some of which were previously described in Table 1.

TABLE 2
Glass transition temperature and tensile properties
of 3D printed parts formed from several di(meth)acrylated
poly(trimethylene ether) glycol compounds

| Compound | T_{g} (° C.) | E_{Y} (MPa) | UTE (%) |
|---|---|---|---|
| PPDA250 | 14 | 93 | 7 |
| PPDA500 | −34 | 36 | 12 |
| PPDA1000 | −56 | 18 | 23 |
| PPDA2000 | −63 | 12 | 40 |
| PPDA2700 | −64 | 7 | 34 |

Table 3 summarizes a range of urethane acrylate compounds, used in the examples of compositions in accordance with embodiments of the present invention. In the examples PPD-UA500/1, PPD-UA1000/1, and PPD-UA1000/2 are used as compound A as described in embodiments of the first aspect. PPG-UA1000/1, PPG-UA2000/2 and PE-UA2000/1 are used in comparative examples in replacement of compound A. Note that PPG-UA1000/1, PPG-UA2000/2 and PE-UA2000/1 are possible examples of compounds that can be used as compound C. Isobornyl acrylate (IBoA) is used as diluent in the examples. The compounds A or the compounds that are used as comparative compounds A comprise a poly-alkylene ether moiety and two urethane acrylate groups that are formed by reaction of a poly(alkylene ether) glycol with isophorone diisocyanate (IPDI) and 2-hydroxyethyl acrylate (HEA). The third column indicates the molar ratio of IPDI and HEA to the precursor. For example, if the third column reads 2/2, it means that if one mole of precursor is used, 2 moles of IPDI and 2 moles of HEA are used. The reaction was performed using techniques known in the art such as those described in WO2020144260. The reported number average molecular weight Mₙ, and the reported weight average molecular weight M_{w}, were measured by GPC with polystyrene as the standard and THF as the elution solvent. The polydispersity Ð=M_{w}/Mₙ was derived therefrom. Viscosities, measured using the technique described above, are also summarized in Table 3.

TABLE 3
Molar mass distribution and viscosity data of several
poly(trimethylene ether) glycol urethane acrylates

| | | IPDI/ | Mₙ | M_{w} | | BBC |
|---|---|---|---|---|---|---|
| Compound | Precursor | HEA | (kDa) | (kDa) | Ð | (w/w %) |
| PPD- | Velvetol ® H250 | 2/2 | 3.4 | 5.2 | 1.53 | ND |
| UA250/1 | | | | | | |
| PPD- | Velvetol ® H500 | 2/2 | 6.8 | 12.9 | 1.91 | ND |
| UA500/1 | | | | | | |
| PPD- | Velvetol ® H1000 | 2/2 | 4.0 | 6.6 | 1.64 | ND |
| UA1000/1 | | | | | | |
| PPD- | Velvetol ® H1000 | 1.5/1 | 9.8 | 19.5 | 2.00 | 69 |
| UA1000/2 | | | | | | |
| PPG- | Polypropylene | 2/2 | 3.1 | 3.8 | 1.22 | — |
| UA1000/1 | glycol 1000 | | | | | |
| | (Dow) | | | | | |
| PPG- | Polypropylene | 1.5/1 | 7.9 | 12.2 | 1.54 | — |
| UA2000/2 | glycol 2000 | | | | | |
| | (Dow) | | | | | |
| PE- | Polyester diol | 2/2 | 5.1 | 9.2 | 1.82 | — |
| UA2000/1 | (adipic acid- | | | | | |
| | neopentylglycol) | | | | | |
| | 2000 | | | | | |

Table 4 summarizes a range of compositions according to embodiments of the present inventions where compound A is a urethane acrylate. Furthermore, the compositions contain diluent isobornyl acrylate (IBoA) (compound B). As can be seen, the viscosity is satisfactory in both the comparative examples and the embodiments of the present invention. However, the Young's modulus is better for the examples according to present invention and provide solid objects that are harder when compared with the comparative examples. It is also found that compositions comprising a precursor with a higher molar mass provide solid objects with a higher Young's modulus. The UTE is comparable between the examples according to present invention and the comparative examples. The same is true for the ultimate elongation at break and for the T_{g}. On the other hand, the impact strength in embodiments according to present invention is satisfactory but equal to or lower than the comparative examples. To summarize, these embodiments of the present invention represent a valid biobased alternative to non-biobased compositions to form solid objects that are stiffer and less prone to deformation.

TABLE 4
Physical properties of 3D parts formed from several poly(alkylene
ether) glycol urethane acrylates. The reported viscosity is
that of the composition before curing to form the 3D parts.

| | Compa 1 | Compa 2 | Compa 3 | Ex 1 | Ex 2 | Ex 3 | Ex 4 |
|---|---|---|---|---|---|---|---|
| PPD-UA1000/2 | | | | 30 | | | |
| PPD-UA1000/1 | | | | | 30 | | |
| PPD-UA500/1 | | | | | | 30 | |
| PPD-UA250/1 | | | | | | | 30 |
| PPG-UA1000/1 | 30 | | | | | | |
| PPG-UA2000/2 | | | 30 | | | | |
| PE-UA2000/1 | | 30 | | | | | |
| IBoA | 70 | 70 | 70 | 70 | 70 | 70 | 70 |
| Sum of | 100 | 100 | 100 | 100 | 100 | 100 | 100 |
| the above | | | | | | | |
| Photoinitiator | 2 | 2 | 1 | 2 | 2 | 2 | 2 |
| (TPO-L) | | | | | | | |
| η_{25° C.} (mPa s) | 89 | 211 | 144 | 305 | 86 | 354 | 240 |
| T_{g} (° C.) | 48 | 67 | 75 | 89 | 73 | 64 | 52 |
| E_{Y} (MPa) | 95 | 216 | 318 | 506 | 526 | 366 | 301 |
| UTE (%) | 135 | 50 | 290 | 36 | 125 | 56 | 96 |
| Impact strength | 2 | 1.9 | 3 | 1.5 | 1.6 | 0.8 | 0.8 |
| (kJ m⁻²) | | | | | | | |

Table 5 summarizes a range of compositions according to embodiments of the present inventions where compound A is obtained by a condensation reaction. Furthermore, the compositions contain diluent isobornyl acrylate (IBoA) (compound B). As can be seen, the viscosity is similar or lower than for the comparative examples and for the embodiments of Table 4. Young's modulus is comparable or better in embodiments of the present invention then for the comparative examples, with the compositions comprising a precursor of lower Mₙ or present in a lower proportion showing a higher Young's modulus. Young's modulus is similar to those observed in Table 4. The T_{g} of these embodiments is either similar or better than for the comparative examples. Importantly, the impact strength is much better than for the comparative examples or for the embodiments of Table 4 as long as more than 20 wt % of compound A is present. To summarize, these embodiments of the present invention represent a valid biobased alternative to non-biobased compositions from the prior art to form solid objects that are stiffer, less prone to deformation, and having an excellent impact resistance.

TABLE 5
Physical properties of 3D parts formed from several poly(alkylene
ether) glycol acrylates. The reported viscosity is that of
the composition before curing to form the 3D parts.

| Composition | Compa 1 | Compa 2 | Compa 3 | Ex 6 | Ex 7 | Ex 8 | Ex 9 | Ex 10 |
|---|---|---|---|---|---|---|---|---|
| PPDA500 | | | | 30 | | | | |
| PPDA1000 | | | | | 30 | | | |
| PPDA2000 | | | | | | 30 | | |
| PPDA2700 | | | | | | | 30 | 20 |
| PPG-UA1000/1 | 30 | | | | | | | |
| PPG-UA2000/2 | | | 30 | | | | | |
| PE-UA2000/1 | | 30 | | | | | | |
| IBoA | 70 | 70 | 70 | 70 | 70 | 70 | 70 | 80 |
| Sum of | 100 | 100 | 100 | 100 | 100 | 100 | 100 | 100 |
| the above | | | | | | | | |
| Photoinitiator | 2 | 2 | 1 | 2 | 2 | 2 | 2 | 2 |
| (TPO-L) | | | | | | | | |
| η_{25° C.} (mPa s) | 89 | 211 | 144 | 25 | 32 | 65 | 83 | 41 |
| T_{g} (° C.) | 48 | 67 | 75 | 52 | 53 | 59 | 60 | 78 |
| E_{Y} (MPa) | 95 | 216 | 318 | 281 | 69 | 96 | 82 | 498 |
| UTE (%) | 135 | 50 | 290 | 83 | 120 | 222 | 240 | 131 |
| Impact strength | 2 | 1.9 | 3 | 15 | >40 | >40 | >40 | 1 |
| (kJ m⁻²) | | | | | | | | |

1. A radical curable composition for forming a solid object comprising
10 wt % to 70 wt % of one or more compounds A, based on the total weight of the composition,
30 wt % to 90 wt % of one or more (meth)acrylate compounds B, which are different from the one or more compounds A, based on the total weight of the composition, and
0 wt % to 25 wt % of one or more compounds C, different from compounds A and B, based on the total weight of the composition,
wherein:
each compound A comprises a poly(trimethylene ether) moiety and one or two (meth)acrylate groups,
the poly(trimethylene ether) moiety is incorporated into compound A by reaction of a poly(trimethylene ether) glycol having a number average molecular weight Mn, measured by GPC with polystyrene as the standard, of from 500 to 5000 Dalton, and a polydispersity Ð, measured by GPC with polystyrene as the standard, of at least 1.5,
each compound B comprises a single (meth)acrylate-moiety,
the one or more (meth)acrylate compounds B, if polymerized together, have a glass transition point (Tg) of more than 30° C., and
the viscosity of the whole composition is less than 5 Pa·s at 25° C.

2. The radical curable composition according to claim 1, wherein the solid object is a self-supporting solid object.

3. The radical curable composition according to claim 1, wherein at least one of the compounds B is selected from isobornyl acrylate, isobornyl methacrylate, norbornyl acrylate, norbornyl methacrylate, α-methylene-γ-butyrolactone, α-methylene-γ-valerolactone, methyl methacrylate (MMA), n-butyl methacrylate (BuMA), tert-butyl methacrylate (tBuMA), cyclohexyl methacrylate (CHMA), benzyl methacrylate (BMA), hydroxyethylmethacrylate (HEMA), and hydroxypropyl methacrylate (HPMA).

4. The radical curable composition according to claim 1, comprising from 12 to 60 wt % of compound A.

5. The radical curable composition according to claim 1, comprising from 40 wt % to 88 wt % of compound B, based on the total weight of the composition.

6. The radical curable composition according to claim 1, wherein the one or more (meth)acrylate compounds B, if polymerized together, have a T_{g} of more than 40° C.

7. The radical curable composition according to claim 1, comprising from 0 wt % to 9 wt % of other compounds C, different from compounds A and B.

8. The radical curable composition according to claim 1, wherein the viscosity of the whole composition is less than 4.8 Pa·s at 25° C.

9. (canceled)

10. (canceled)

11. A method of forming a solid object comprising submitting the radical curable composition according to claim 1, to curing conditions.

12. A solid object comprising a cured radical curable composition according to claim 1.

13. The solid object according to claim 12, being a self-supporting object.
